(19) United States
(12) Patent Application Publication
(10) Pub. No.: US 2003/0046168 A1
(43) Pub. Date: Mar. 6, 2003

(54) System and method for operating information terminals

(76) Inventor: Andreas Muller, Gutersloh (DE)

Correspondence Address: HUSCH & EPPENBERGER, LLC, 401 MAIN STREET, SUITE 1400, PEORIA, IL, 61602, US

(21) Appl. No.: 10/232,004

(22) Filed: Aug. 29, 2002

(30) Foreign Application Priority Data
Aug. 29, 2001 (EP) 01 120 827.9

(51) Int. Cl. G06G 1/12; G06F 17/60; G06G 1/14

(52) U.S. Cl. 705/21; 705/22

(57) ABSTRACT

A system and a method for operating information terminals is described, in which a system user provides a plurality of information terminals for customers. Each information terminal has a playback station and a scanning device. The scanning device is used to scan a product identification applied to a data carrier product. The information terminal requests information on the scanned product identification from a local data processing apparatus. A remote central station is connected to the local data processing apparatus. The remote central station has an archive. The central station provides the information destined for playback from the archive to the local data processing apparatus. Data for at least one commercial spot are provided from the central station, such that the commercial spot in addition to the information on the data carrier product is run for the customer at the playback station.

### TECHNICAL FIELD OF THE INVENTION

The invention relates generally to supplying information to customers and, more particularly, to a system and a method for operating information terminals, in which a system user provides a plurality of information terminals for customers.

### DESCRIPTION OF THE RELATED ART

A system for operating information terminals is known from DE 299 14 175 U1 of the same applicant under the name “Music Browser.” In the known system, a local data processing apparatus is installed at the system user site. With the aid of the scanned product identification, which is, for example, applied to the package of a CD as a barcode, the local data processing apparatus obtains information destined for the customer. The information may include music clips, video clips or computer game clips. The information is retrieved from a local database and output to the customers by a playback station. The information is transmitted to the local data processing apparatus from a remotely arranged central station. This central station contains an archive of a plurality of such music clips, video clips or computer game clips, i.e. identical or similar data of a plurality of data carrier products. The identical or similar data is designed to give the customer a good impression, as well as an overview over the respective data carrier product. With the aid of the central station, the system user can update his local database. Up to several million pieces of data carrier products can be kept ready in the central archive, from which a plurality of system users can obtain the required information. In this way, a customer can trial-listen or, respectively, trial-view a CD or a DVD or CD-ROM and is thereby positively influenced with regard to his purchase decision. The CD or DVD itself does not have to be taken out of the package but can be retrieved from the local database via the local data processing apparatus. The playback station with the scanning device can be operated by the customer himself. In this way, the trial-playing of CDs or DVDs in a sales store is automated. The aforementioned DE 299 14 175 U1 is herewith incorporated in the disclosure of the present invention by reference.

From EP 0 969 469 A1 of the same applicant, a method for providing pieces of music is known, in which the information on a data carrier product, e.g. a CD or DVD, is transmitted in online mode from a central station to the local data processing apparatus and the local database. A playback station plays at least a part of the information stored on the CD or DVD for trial-listening and trial-viewing. The aforementioned EP 0 969 469 A1 is herewith incorporated in the disclosure of the present patent application by reference.

Further, in WO 98/02885 of the same applicant, there is described an archive in the form of a database. In this archive, a plurality of pieces of data carrier products can be stored. This publication, too, is incorporated in the content of the present patent application by reference.

It is desirous for a system user to provide several information terminals, wherein each information terminal has a playback station for the audio and/or visual playback of at least a part of the information that is stored on a data carrier product destined for sale, such as a CD (Compact Disc with audio signals), a DVD (Digital Versatile Disc with audio and video information) or a computer game (e.g. a CD-ROM with software, audio and video data). A scanning device which scans a product identification applied to the data carrier product is mounted on each information terminal.

### SUMMARY OF THE INVENTION

An aspect of the invention is to provide a system and a method for operating information terminals that increases the comfort for the customer and provides additional information as well as offer economic advantages for the system user.

Another aspect of the present invention is to provide a system wherein the local data processing apparatus is provided with data for at least one commercial spot that is output to the customer in addition to the information on the data carrier product at the playback station of the information terminal. The commercial spot can contain audio and/or visual information.

In yet another aspect of the present invention, there is provided a playback station with two functions. One function allows for trial-listening or, respectively, trial-viewing of data carrier products. The other function allows for informing the customer with the aid of commercial spots. In this way, the technical equipment at the system user site for supporting the sale and for increasing the comfort for the customer is better utilized. In practice, it has shown that the information terminals are accepted to a high extent by the customers in a sales store and are used for trial-listening or, respectively trial-viewing. Such an information terminal is highly frequented and thus particularly suitable for further informing the customer without annoying him given a direct approach by the sales staff.

According to a further aspect of the invention, a method for operating information terminals is specified. The method employs the aforementioned system and provides the advantages and technical effects already explained in conjunction with the system.

The system and method for operating information terminals is utilized by a system user. The system user is, for example, a trading company, possibly with several branches, the company being in close data communication with a system operator of the central station. At the system user's end is a local data processing apparatus, whereas at the system operator's end there is a central data processing apparatus. Preferably the data traffic between the local data processing apparatus and the central data processing apparatus is carried out via the IP-network (Internet-Protocol) over the worldwide Internet.

In one embodiment of the invention, the required commercial spots can be stored by the system user in a local database. In this case, the system user himself has to provide for the preparation of the commercial spot and for the software-technical management of the commercial spot.

In a preferred alternative, the central station provides a commercial spot-database, in which a plurality of commercial spots are stored, the system user selecting at least one commercial spot, which, for example, is transmitted to the local database and is output by the playback station. Given this alternative, the commercial spots or, respectively, the data, are prepared and software-technically managed in the central station. In this way, different system users can take advantages of the central commercial spot-database. It might also be possible that different system users retrieve the same commercial spot from the commercial spot-database. Moreover, the common management of the commercial spots for different system users increases profitability.

A particular embodiment of the invention provides that the data determined by the scanning device which reads the product identification applied to the data carrier product, for example, in the form of a bar code, are statistically evaluated. This evaluation can, for example, take place in the local data processing apparatus. Preferably, however, the statistics are created in the central data processing apparatus. The system user can then fetch the statistical data via the central data processing apparatus. With the aid of the statistical data, the system user is informed about the behavior of the customers. For example, the statistics can represent the frequency of scanned data carrier products. On the basis of this frequency, with which customers access a certain data carrier product, the system user can find out very quickly which data carrier products are particularly demanded. In this way, he can optimize his stock and improve the profitability. For example, the statistics can also represent a ranking list of the various offered data carrier products. Such a ranking list can be created per day or per week and/or for each information terminal or for groups of information terminals. On the basis of this ranking list, the system user can determine the customer behavior and make corresponding arrangements.

According to a further embodiment, the information terminal has a product presentation area which lies in the access area of the customer during the playback of the audio and/or visual information on the playback station. At least one product destined for sale is presented in the product presentation area. The information terminal is operated by the customer himself For example, when trial-listening to a CD, the customer puts on the headphone, adjusts the desired volume and listens to the music. While listening to the music he stays at the location of the information terminal and lets his eyes roam. If a product is now presented in the access area of the customer, then this product is inevitably particularly noticed by the customer. This attention can result in that he is interested in this product in more detail. The product does not necessarily have to be a data carrier product; for example other small devices or even only models thereof can likewise be presented. Preferably, however, the presented product is a product which is up-to-date and in which a broad clientele is interested.

It is particularly advantageous if the commercial spot which is played by the playback station, and output in addition to the information on the data carrier product selected by the customer, relates to the product presented in the product presentation area. This data carrier product can, for example, be a piece having a high rank in a hit list or it can be presented on the basis of other marketing considerations. Thus, by means of the commercial spot, the customer is additionally informed on the data carrier product presented in the product presentation area and its curiosity is further aroused.

A development of the system provides that the system user selects the data carrier product to be presented at one or several information terminals in the respective product presentation area dependent on the determined statistical data. Yet the selection may also be independent of the statistical data. For example, if a certain data carrier product is only demanded little in the sales store of a system user, whereas he knows from the observation of competitors that this data carrier product is very popular with the customers, then, in order to increase the demand in his store, he can select such a data carrier product for the product presentation area, thereby increasing the demand.

Another development can provide that statistical data are determined at selected information terminals, for example, at test information terminals which have a particular market position. In sales stores or even in certain branches there may be a certain clientele available at certain information terminals, the clientele being particularly sensitive to new products. By observing these customers and their demand behavior, a sales trend can be determined. The statistical data of such test information terminals can then be used in order to have an influence on the purchase behavior of a broader clientele. For example, it is conceivable that such information terminals are set up in sales stores with trend-setting character. In sales stores which have a more provincial character and corresponding clientele, then those data carrier products are advertised by means of commercial spots and product presentation which have been preferably selected by the clientele having a trend-setting behavior.

The system can be used particularly advantageously if the system user manages information terminals in several branches which are spatially separated from one another. Each information terminal can be controlled via the central data processing apparatus. Then, the system user can control the running of commercial spots by means of access to the central data processing apparatus. Moreover, the system user can control the presentation of products in the product presentation area by access to the central data processing apparatus. In this way, a system user can improve the demand in his sales stores and can optimize his market strategy. Several information terminals can also be combined in one group. These information terminals are then identically controlled and evaluated within the group, preferably via the Internet.

According to one embodiment, the system is characterized in that the central data processing apparatus comprises an internet portal. The system user accesses the data provided by the internet portal via the Internet with the aid of an access procedure that identifies him. The data may include, for example, music clips, video clips or computer game clips, information on data carrier products, the commercial spot-data, the statistical data, and control data for the presentation of products in the product presentation area.

### BRIEF DESCRIPTION OF THE DRAWINGS

Reference is now made to the drawings which illustrate the best known mode for carrying out the invention:

FIG. 1 shows a block diagram of the local part;

FIG. 2 shows a block diagram of the central station;

FIG. 3 is an overview in the form of a block diagram for a system user having several branches;

FIG. 4 illustrates a part of a prototype of an information terminal with a product presentation area;

FIG. 5 illustrates a web page with statistics on the total number of customer contacts for a sales store;

FIG. 6 illustrates a web page with a ranking list of the titles demanded by the customers; and

FIG. 7 illustrates a one-week statistics on the CDs listened to at different information terminals.

### DETAILED DESCRIPTION

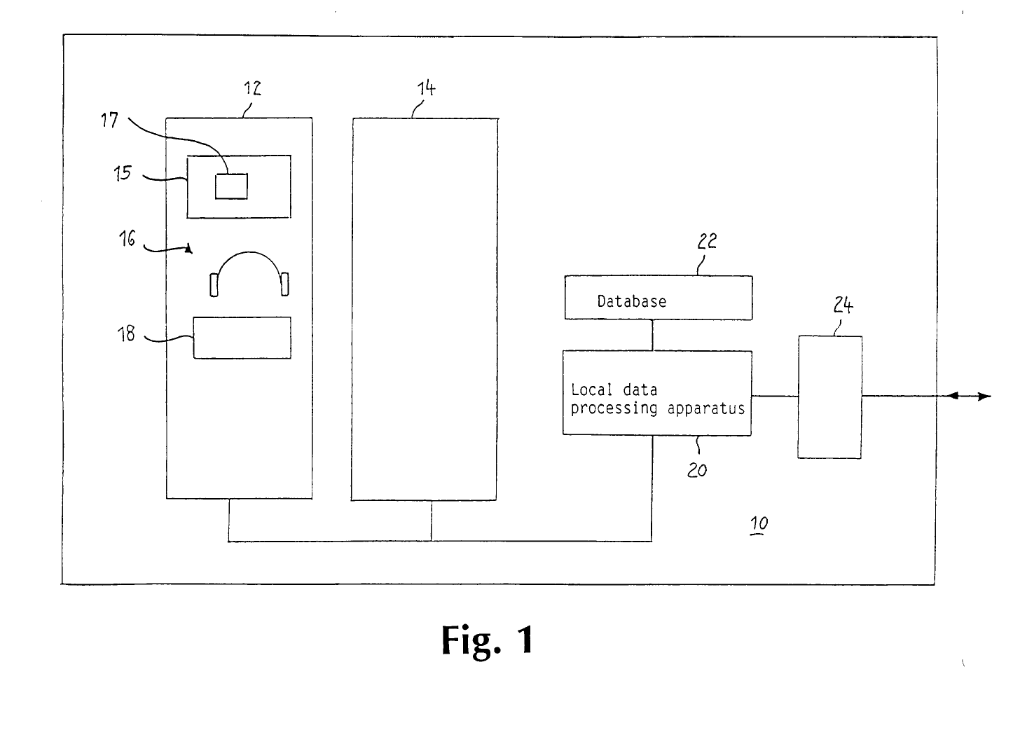

FIG. 1 shows a local part 10 of the system for operating information terminals. The local part 10 includes a plurality of information terminals. In this example, the local part 10 includes two information terminals 12 and 14, which are identically structured. Only the information terminal 12 is illustrated in more detail. The local part 10 can, of course, comprise a much greater number of information terminals. The information terminal 12 has a playback station 16 in the form of a headphone for trial-listening of CDs. In the case of trial-viewing DVDs or computer games, the playback station has a video playback device, for example, a personal computer with monitor and corresponding further devices. In addition, the playback station includes adjusting devices (not shown) for adjusting the volume, for track switching, for forwarding and rewinding, and possibly other actuators, such as consoles for computer games. Further, the information terminal 12 includes a scanning device 18. The scanning device 18 can be used to scan a barcode applied as a product identification to the package of a data carrier product, such as a CD, a DVD or a computer game. In the immediate visibility and access area of a customer, a product presentation area 15 for the presentation of a product 17 is arranged above the playback station 16.

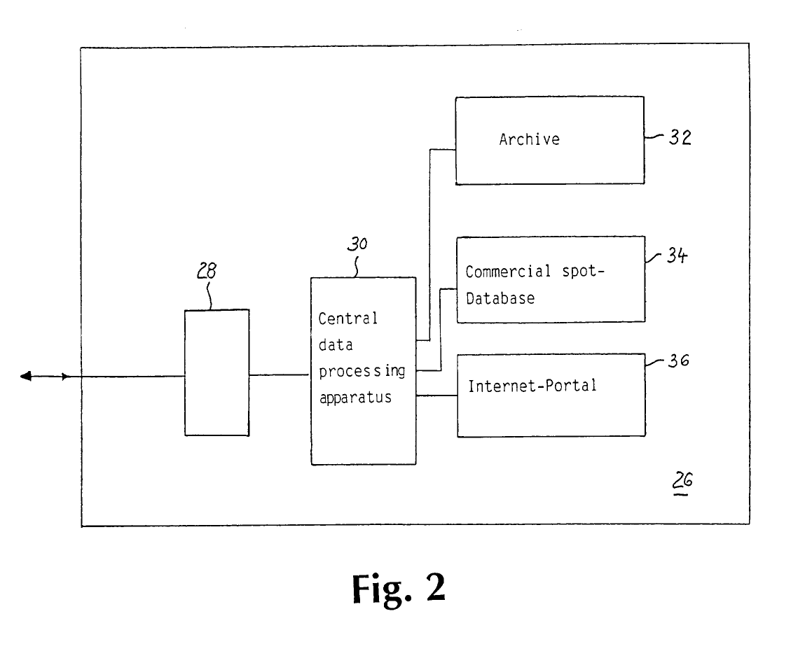

Both information terminals 12 and 14 are connected to a local data processing apparatus 20 which in turn has access to a local database 22. The local data processing apparatus 20 is also termed a local controller. In this local database 22, for example, data of music clips or video clips are stored. The local data processing apparatus 20 is connected to a central station 26 via an interface 24 to the IP network (Internet Protocol). The structure of the central station 26 is schematically illustrated in FIG. 2.

FIG. 2 is a block diagram of the central station 26. Via an interface 28 to the IP network, a central data processing apparatus 30 is connected thereto. This central data processing apparatus 30 accesses an archive 32 in the form of a data base in which the data of a plurality of music clips and video clips and data on computer games are stored which are allocated to the data carrier products to be sold. The number of pieces stored can amount to several millions.

Further, the central data processing apparatus 30 accesses a commercial spot-database 34, in which data on commercial spots are stored. These commercial spots are managed by the data processing apparatus 30.

As a further block, an internet portal 36 is illustrated which is realized as software for internet access via the central data processing apparatus 30. A system user uses this internet portal 36 by accessing the internet portal 36 via the worldwide IP network, by identifying himself as being authorized for access and by retrieving and/or adjusting the data required for him via a menu mode in the internet portal 36 and/or by initiating control functions.

The embodiment of the entire system, comprising the parts 10 and 26, works as follows. A system user logs himself in via the internet portal 36 and loads his local database 22 with information, for example music clip data or video clip data, from the archive 32 in the online mode. These data relate to the data carrier products for sale in the sales store of the system user. The refreshing of the local database 22 with current data from the archive 32 can take place at regular intervals or automatically.

A customer in the sales store of the system user picks out one data carrier product from a stock of data carrier products, for example, CDs or DVDs, and holds the package with the label on which a barcode is printed under the scanning device 18. The scanning device 18 scans the barcode and transmits the information to the local data processing apparatus 20. The local data processing apparatus 20 retrieves from the local database 22 the information, such as audio data or video data, belonging to the scanned product. The data are supplied to the playback station 16. The customer can trial-listen to and/or trial-view the data carrier product through this playback station 16, for example, a headphone or monitor.

The system user further selects one or more commercial spots from the commercial spot-database 34 via the central station 26; the commercial spot and the information are forwarded to the local data processing apparatus 20 and the local database 22. While the customer listens to or views information on the data carrier product on a trial basis, these commercial spots are run. During this trial-listening and trial-viewing, the customer is bound to the location of the information terminal 12. His attention is drawn to the product presentation area 15 in which the product 17, for example, one or more data carrier products, are presented.

In the case of an initial installation, the local database 22 is provided with data according to a stock list of the relevant sales store of the system user. The update of the data stock required afterwards due to the change in the stock of goods can take place automatically in the following manner. A customer takes a data carrier product not present in the local database to the information terminal 12 and scans the product identification. The local data processing apparatus 20 recognizes that the data required are not present and requests the data from the central station 26 via the IP network. The central station 26 then sees to it that the data are sent from the central archive 32 to the local database 22 via the IP network and are forwarded therefrom to the information terminal 12.

In another alternative of the invention, the local database 22 can be omitted. Each of the information terminals 12, 14 is directly connected to the central station 26 via the IP network and obtains the necessary data from the archive 32 or from the commercial spot-database 34, either directly or via the local data processing apparatus 20. The control function of the local data processing apparatus 20 can also be assigned to the respective information terminal, wherein each information terminal 12, 14 has its own computer. Preferably, each information terminal 12, 14 has its own IP address so that it can communicate directly with the central station 26 via this IP address. In another alternative, several information terminals are combined in a group, which has its own group-specific IP address.

In conjunction with the commercial spots to be run, the following advertising measures are preferably taken. The advertising measures can be broken down into three broad categories: “pre-listening,” “rotation,” and “introduction.” For “pre-listening,” advertising information is run which refers to a data carrier product that is not yet commercially available, but can be listened to or viewed in advance on a trial basis. In this way, the curiosity of the customer with regard to this data carrier product is aroused.

The “rotation” advertising measure involves commercial spots that are run automatically when there are breaks between the running of information on data carrier products. For example, in the break between two pieces, such as two songs, a commercial spot can be placed. The advertising can also be effected on external loudspeakers or video screens.

In the “introduction” advertising measure, a commercial spot is run each time as an introduction before the running of the information on a data carrier product. In addition, for intensifying the advertising measure, a corresponding product can be presented in the product presentation area, such as one or several CDs.

The system user can also select the commercial spots such that they contain information which is not related to the data carrier product and, for example, refer to small electronic devices or other products. Further, it is possible that the commercial spot contains general information and, for example, relates to a general advertising message on a company.

Preferably a data carrier product on which information is provided in the commercial spot is presented as a product 17 in the product presentation area 15. Since the customer is tied to the location of the information terminal 12, his attention is also drawn to the product 17 in the product presentation area 15. By the information on this product in the commercial spot, the advertising for this product is further increased.

As will be explained in more detail below, the system user can obtain statistical data on the frequency of the use of the information terminals 12,14 via the internet portal 36. Further, he can obtain statistical data on the frequency of the use of certain data carrier products. With the aid of this information, the system user can determine the data carrier product 17 to be presented in the product presentation area 15 and thus promote its sale.

To the advantage of the system user, the information terminals 12, 14 can be used for further advertising campaigns, the scanning device 18 being used in particular. An advertising carrier, for example a post card, having a barcode can, for example, be used as a data carrier product. In the case of a postcard, a barcode is printed thereon. The customer takes this data carrier product to an information terminal 12 or 14 and scans it is informed via the playback station 16 with the aid of predetermined information. The information can be provided, for example, by the archive 32 and/or the commercial spot-database 34 and/or the local database 22. For example, a lure advertising measure, such as a postcard, is sent to the customer with a promise of winning, for example, a lottery. The customer visits the sales store of the system user with this postcard; at the information terminal 12 or 14 the barcode applied to the postcard is scanned and the customer is informed about this data carrier product and is provided with commercial spots.

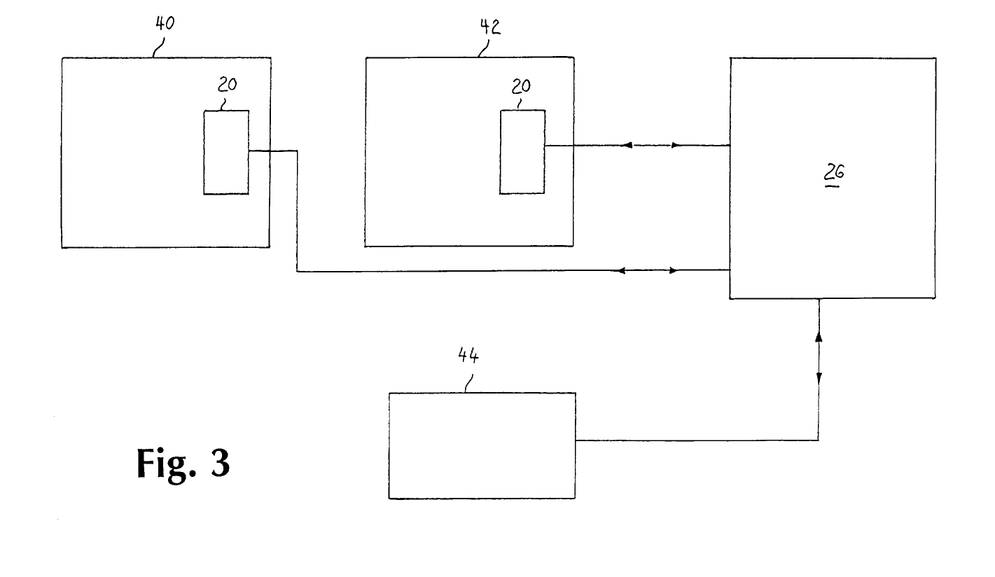

FIG. 3 illustrates in a schematic block diagram branches 40, 42 of a system user. While only two branches are shown in the present embodiment, it is understood that numerous branches may be incorporated in another embodiment. Each branch 40, 42 includes a local data processing apparatus 20, each of which being connected to the central station 26. The system user can access the internet portal 36 of the central station 26 via an IP terminal 44 which is typically located in one of the branches 40, 42, however it can be present at any arbitrary location. In this way, a system user can control the information terminals present in the different branches 40, 42 via the central station 26 and can provide them with information and commercial spots via the central station 26. It is also useful to combine several information terminals in one group and to provide this group with the same data. The information terminals can also be controlled separately from branch to branch or jointly. Further, with corresponding local controllers, it is possible that the different information terminals or groups thereof are each connected directly with the central station 26 via the IP network.

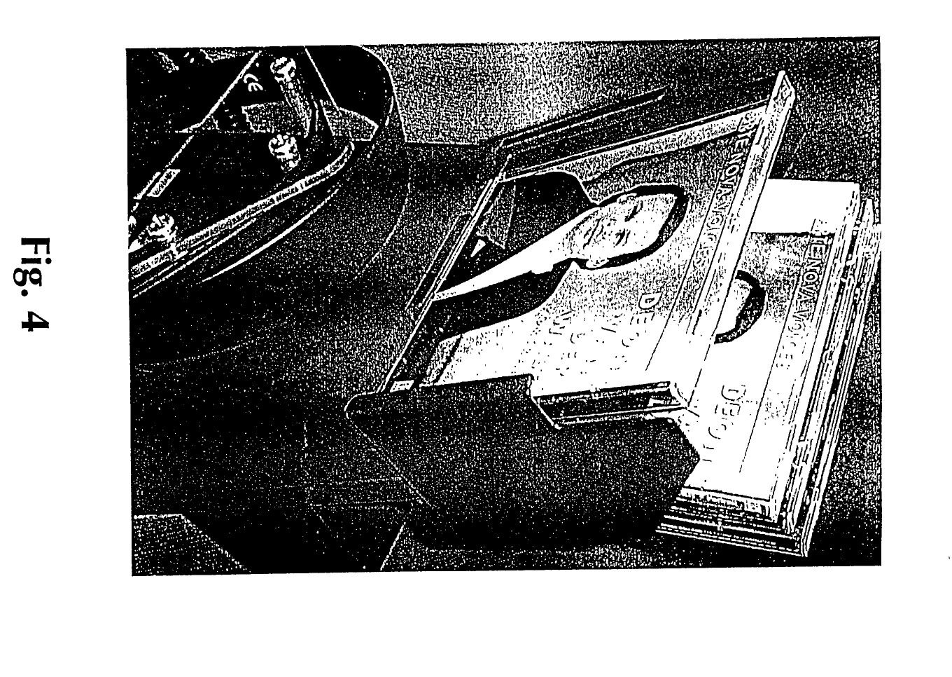

FIG. 4 shows a part of a prototype of an information terminal. In the upper part of FIG. 4, the product presentation area can be seen, in which four CDs are presented as data carrier products. In the lower part of the figure on the left-hand side, a headphone can be seen as a playback station. As can readily be seen, the product presentation area is arranged in immediate proximity and in the direct visible access area of the customer when he puts on the headphone for trial-listening.

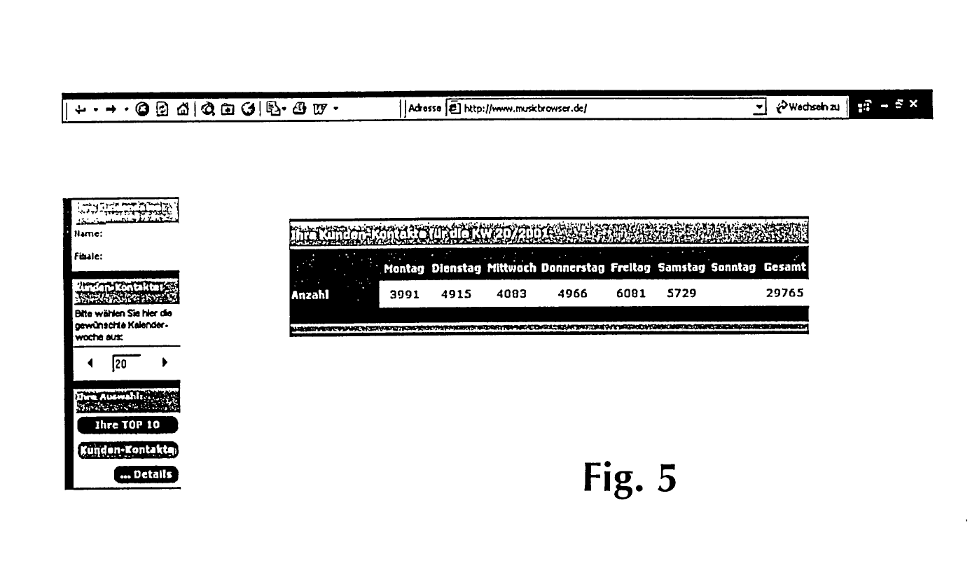

FIG. 5 illustrates a web page which can be accessed by a system user. On this web page, statistical data on the customer contacts for the 20th calendar week are represented in a daily table. In the left part of the web page, it can be seen that the system user gets a menu-controlled user guidance.

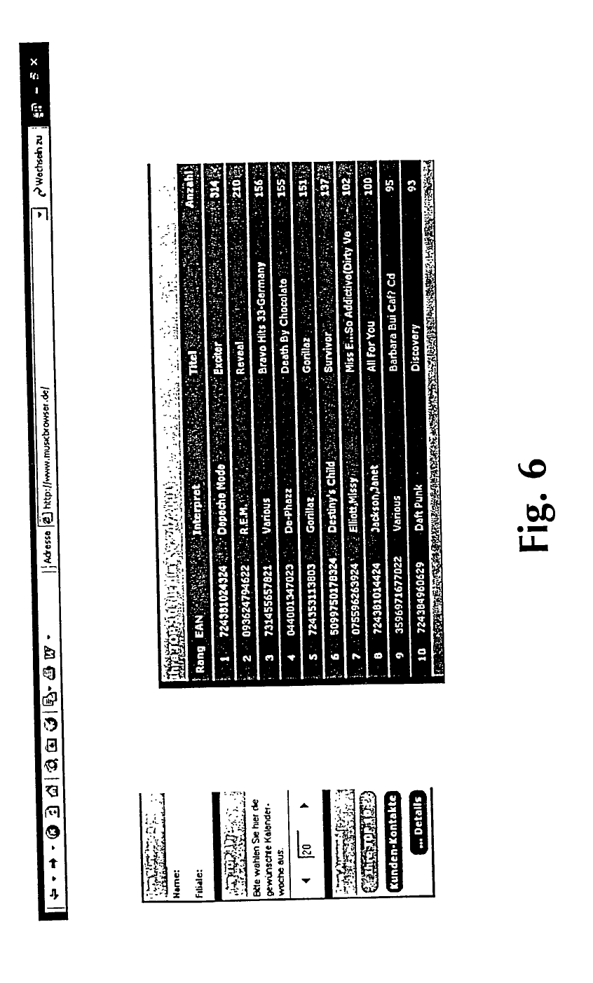

FIG. 6 shows a web page with a ranking list of the pieces of music run by the customers. The system user can adjust or, respectively, amend his product presentation and his commercial spots on the basis of this ranking list.

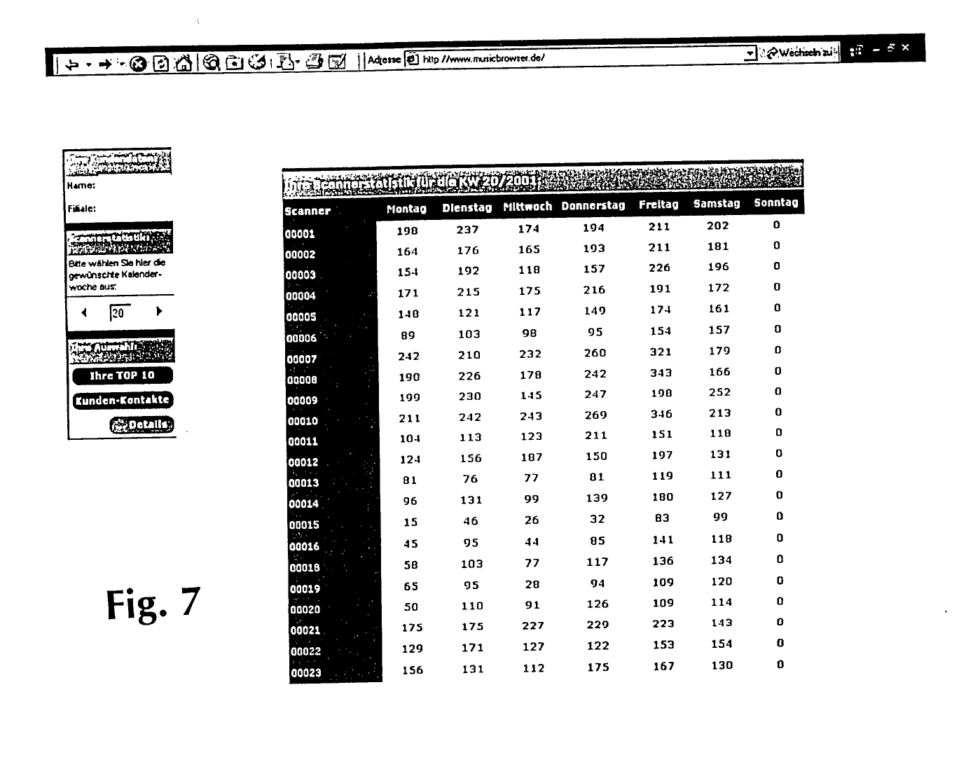

FIG. 7 shows a detailed overview on the scanned data carrier products at different information terminals in a weekly table.

Other aspects, objects and advantages of the present invention can be obtained from a study of the drawings, the disclosure and the accompanying claims. The invention in its broader aspects is not limited to the specific steps and apparatus shown and described but departures may be made therefrom within the scope of the accompanying claims without departing from the principles of the invention and without sacrificing its chief advantages.

What is claimed is:

1. A system for operating information terminals, comprising:
a plurality of information terminals for customers;
each information terminal including a playback station for playback of at least a part of the information stored on a data carrier product destined for sale;
each information terminal further including a scanning device for scanning a product identification applied to the data carrier product;
a local data processing apparatus for requesting part of the stored information on the basis of the product identification scanned and transmitting the same to the playback station;
the local data processing apparatus including data for at least one commercial spot and operative to add such data to the information about the data carrier product transmitted to the playback station; and
a remote central station having a central data processing apparatus operatively connected to the local data processing apparatus;
the central station further including an archive that contains data for a plurality of data carrier products and means to provide the information destined for playback to the local data processing apparatus; and
whereby the product identification is scanned, the local data processing apparatus makes a request for the stored information about the product data carrier scanned, the remote central station responds to the request, the remote central station transmits the stored information, and the local data processing apparatus adds the commercial spot to the information transmitted to the playback station so that the output to the customer at the playback station includes the commercial spot and the transmitted information about the data carrier product.

2. The system for operating information terminals according to claim 1, wherein the local data processing apparatus is operatively connected to a local database for storing the information about the data carrier products and commercial spots.

3. The system for operating information terminals according to claim 1, wherein the local data processing apparatus is operatively connected to the central data processing apparatus via an IP network, such that the data are exchanged via the IP network.

4. The system for operating information terminals according to claim 3, the central station further comprising:
a commercial spot-database for storing a plurality of commercial spots; and
means for interaction by a system user with the commercial spot database, such that the system user utilizes the interaction means to select at least one commercial spot to be transmitted to the local data processing apparatus and run by the playback station.

5. The system for operating information terminals according to claim 4, wherein the commercial spot-database includes software to technically manage the commercial spots.

6. The system for operating information terminals according to claim 1, further including means for statistically evaluating the scanned product identifications.

7. The system for operating information terminals according to claim 1, further including means for statistically evaluating the scanned product identifications over discrete periods of time.

8. The system for operating information terminals according to claim 6, wherein the discrete period of time is one week.

9. The system for operating information terminals according to claim 6, in which the statistical evaluation means is the central data processing apparatus;
the central data processing apparatus including software to prepare the statistical data; and
the central data processing apparatus further including means for interaction by a system user such that the system user can retrieve these statistical data from the central data processing apparatus.

10. The system for operating information terminals according to claim 6, in which the information terminal includes a product presentation area;
the product presentation area lies in an access area of the customer during the playback of information on the playback station; and
the information terminal presents at least one product in the product presentation area.

11. The system for operating information terminals according to claim 10, wherein the at least one product is a data carrier product.

12. The system for operating information terminals according to claim 10, wherein the commercial spot played by the playback station relates to the product presented in the product presentation area.

13. The system for operating information terminals according to claim 1, wherein the commercial spot includes information which relates to a specific data carrier product.

14. The system for operating information terminals according to claim 1, wherein the commercial spot includes information which relates to a data carrier product that is soon offered for sale.

15. The system for operating information terminals according to claim 10, wherein the commercial spot includes information which relates to a product.

16. The system for operating information terminals according to claim 10, wherein the system user determines the data carrier product to be presented at one or several information terminals in the respective product presentation area dependent on the statistical data.

17. The system for operating information terminals according to claim 16, wherein the statistical data are associated with predetermined information terminals.

18. The system for operating information terminals according to claim 10, wherein a system user manages several branches of spatially separated information terminals;
the system user controls each information terminal via the central data processing apparatus; and
the central data processing apparatus further including means for interaction, such that the system user controls which commercial spots are run through the interaction means.

19. The system for operating information terminals according to claim 18, wherein the system user controls which products are presented in the product presentation area through the interaction means.

20. The system for operating information terminals according to claim 18, wherein the interaction means comprises:
an internet portal; and
an authorization procedure for identification, such that the system user utilizes the authorization procedure to access the internet portal.

21. The system for operating information terminals according to claim 1, wherein the data carrier product is selected from the group consisting of a CD, a DVD or a computer game.

22. The system for operating information terminals according to claim 1, wherein the data carrier product is an advertising carrier with a barcode.

23. The system for operating information terminals according to claim 1, wherein the plurality of several information terminals are combined group-wise and the commercial spots are run group-wise.

24. The system for operating information terminals according to claim 23, wherein each terminal information group further comprises:
at least one computer-based control; and
an IP address for direct data communication with the central station.

25. The system for operating information terminals according to claim 1, wherein each information terminal further comprises:
a computer-based control; and
an IP address for direct data communication with the central station.

26. A method of operating information terminals, comprising the steps of:
providing a plurality of information terminals for customers, wherein each information terminal includes a playback station and a scanning device, the playback station is for the playback of at least a part of the information stored on a data carrier product destined for sale and the scanning device is for scanning a product identification applied to the data carrier product;
providing a local data processing apparatus;
providing a remote central station, wherein the central station includes a central data processing apparatus and an archive, the central data processing apparatus is operatively connected to the local data processing apparatus;
scanning the product identification;
requesting information from the central station based the product identification scanned;
processing the request for information in the central data processing apparatus;
identifying at least one commercial spot;
retrieving the information from the archive;
sending the commercial spot and the information to the local data processing apparatus; and
outputting the commercial spot and the information to the customer.

27. A method of operating information terminals, comprising the steps of:
providing a plurality of information terminals for customers, wherein each information terminal includes a playback station and a scanning device, the playback station is for the playback of at least a part of the information stored on a data carrier product destined for sale and the scanning device is for scanning a product identification applied to the data carrier product;
providing a local data processing apparatus;
providing a local database;
scanning the product identification;
requesting information from the local database based on the product identification scanned;
processing the request for information in the local data processing apparatus;
identifying at least one commercial spot;
retrieving the information from the local database;
sending the commercial spot and the information to the local data processing apparatus; and
outputting the commercial spot and the information to the customer.

28. The method of operating information terminals according to claim 26, further comprising the step of:
connecting the central data processing apparatus to the local data processing apparatus via an IP network.

29. The method of operating information terminals according to claim 26, wherein the central station includes a commercial spot-database having a plurality of commercial spots, further comprising the step of:
selecting at least one commercial spot from the commercial spot-database, whereby the selected commercial spot is sent to the local data processing apparatus and run by the playback station.

30. The method of operating information terminals according to claim 29, further comprising the steps of:
transmitting a commercial spot to the commercial spot-database; and
managing the commercial spot-database through software.

31. The method of operating information terminals according to claim 26, further comprising the step of:
statistically evaluating the scanned product identifications.

32. The method of operating information terminals according to claim 26, further comprising the step of:
statistically evaluating the frequency at which certain data carrier products are scanned.

33. The method of operating information terminals according to claim 32, wherein the statistical evaluation is based on one week period of time.

34. The method of operating information terminals according to claim 31, wherein the statistical evaluation is accomplished by the data processing apparatus, further comprising the step of:
retrieving the statistical data from the central data processing apparatus.

35. The method of operating information terminals according to claim 26, wherein the information terminal includes a product presentation area, further comprising the step of:
presenting at least one product in the product presentation area.

36. The method of operating information terminals according to claim 26, wherein the information terminal includes a product presentation area, further comprising the step of:
presenting at least one data carrier product in the product presentation area.

37. The method of operating information terminals according to claim 35, further comprising the step of:
presenting the commercial spot related to the product.

38. The method of operating information terminals according to claim 36, further comprising the step of:
presenting the commercial spot related to the data carrier product.

39. The method of operating information terminals according to claim 36, further comprising the step of:
presenting the commercial spot related to a soon-offered-for-sale data carrier product.

40. The method of operating information terminals according to claim 26, wherein the commercial spot includes information related to a product.

41. The method of operating information terminals according to claim 31, further comprising the step of:
analyzing the statistical evaluation of the product identifications;
selecting the data carrier product based on the analysis; and
presenting the selected data carrier product in the product presentation area of at least one information terminal.

42. The method of operating information terminals according to claim 26, further comprising the step of:
statistically evaluating scanned product identifications at predetermined information terminals.

43. The method of operating information terminals according to claim 26, wherein the plurality of information terminals are spatially separated, further comprising the steps of:
controlling each information terminal via the central data processing apparatus;
accessing the central data processing apparatus; and
selecting which commercial spots are run on each information terminal.

44. The method of operating information terminals according to claim 43, further comprising the step of:
selecting which products are presented in the product presentation area.

45. The method of operating information terminals according to claim 26, wherein the central data processing apparatus comprises an internet portal, further comprising the steps of:
providing an authorization procedure;
identifying a system user with the authorization procedure; and
accessing the data provided by the internet portal via the Internet.

46. The method of operating information terminals according to claim 26, wherein the data carrier product is selected from the group consisting of a CD, a DVD or a computer game.

47. The method of operating information terminals according to claim 26, wherein the data carrier product is an advertising carrier with a barcode.

48. The method of operating information terminals according to claim 26, further comprising the steps of:
providing information terminals in a group; and
presenting the commercial spots in the same group order.

49. The method of operating information terminals according to claim 48, wherein each information terminal group includes at least one computer-based control and an IP address, further comprising the step of:
directly communicating data between the central station and the information terminal group.

50. The method of operating information terminals according to claim 26, wherein each information terminal includes a computer-based control and an IP address, further comprising the step of:
directly communicating data between the central station and the information terminal.

51. A system for operating information terminals, comprising:
a plurality of information terminals for customers;
each information terminal including a playback station for playback of at least part of the information stored on a data carrier product;
each information terminal further including a scanning device for scanning a product identification applied to the data carrier product;
a database for storing information on a plurality of data carrier products and on a plurality of commercial spots; and
a data processing apparatus for requesting part of the stored information based on the product identification scanned, adding a commercial spot, and transmitting part of the stored information plus the commercial spot to the playback station, wherein the data processing apparatus is operatively connected to the database; and
whereby the product identification is scanned, the data processing apparatus makes a request for the stored information about the product data carrier scanned from the database, the data processing apparatus adds a commercial spot, the data processing apparatus transmits the stored information plus the commercial spot to the playback station so that the output to the customer at the playback station includes the commercial spot and the transmitted information about the data carrier product.

52. A method of operating information terminals, comprising the steps of:
providing a plurality of information terminals for customers, wherein each information terminal includes a playback station and a scanning device, the playback station is for the playback of at least a part of the information stored on a data carrier product destined for sale and the scanning device is for scanning a product identification applied to the data carrier product;
providing a data processing apparatus;
providing a database operatively connected to the data processing apparatus;
scanning the product identification;
requesting information from the database based on the product identification scanned;
processing the request for information in the data processing apparatus;
identifying at least one commercial spot;
retrieving the information from the database;
sending the commercial spot and the information to the data processing apparatus; and
outputting the commercial spot and the information to the customer at the playback station.
